(19) United States
(12) Patent Application Publication
(10) Pub. No.: US 2026/0363938 A1
(43) Pub. Date: Nov. 19, 2026

(54) FOLDING WALKING AID

(71) Applicant: Zhejiang Mateside Medical Devices Technology Co., Ltd., Hangzhou (CN)

(72) Inventors: Zhikuo Liu, Hangzhou (CN); Zhihao Liu, Hangzhou (CN); Jing Wang, Hangzhou (CN); Xiangmeng Ye, Hangzhou (CN); Zhixiang Fan, Hangzhou (CN)

(21) Appl. No.: 19/674,194

(22) Filed: May 12, 2026

(30) Foreign Application Priority Data
May 14, 2025 (CN) 202510615478.3

(51) Int. Cl. A61H 3/04

(52) U.S. Cl. CPC A61H 3/04; A61H 2201/0161; A61H 2201/1635

(57) ABSTRACT

The present disclosure provides a folding walking aid, and relates to the technical field of medical devices, specifically including: a support mechanism, a folding frame, a support member, a leg assembly, a first locking assembly, and a second locking assembly. When storage is required without use, a self-locking structure of the folding frame is unlocked, the folding frame is folded to reduce a length of the folding walking aid and simultaneously unlock the first locking assembly, to enable the support member and a first leg to rotate relative to each other, thereby achieving folding of the folding walking aid in a height direction and simultaneously unlocking the second locking assembly, enabling the first leg and the second leg to rotate relative to each other to reduce a width of the folding walking aid, and realizing three-dimensional folding in length, height, and width directions.

### CROSS REFERENCE TO RELATED APPLICATION

The present disclosure claims the priority to the Chinese patent application with the filing No. 2025106154783 filed with the China National Intellectual Property Administration on May 14, 2025, and entitled “FOLDING WALKING AID”, which is incorporated herein by reference in entirety.

### TECHNICAL FIELD

The present disclosure relates to the technical field of medical devices, and in particular, to a folding walking aid.

### BACKGROUND

A walking assistance device, also known as a lower limb orthosis, is a supportive walking tool used by elderly individuals with limited mobility, certain trauma patients, hemiplegic patients, and disabled persons for self-assisted walking or limb strength training. Users can walk slowly and easily while holding onto it.

To further enhance the convenience of the walking assistance device, a folding walking aid has been introduced. Compared with ordinary walking aids, the folding walking aid is lighter and can reduce a volume by folding before and after use, which is easily carried and stored before and after use and occupies less space.

However, the folding walking aid mainly achieves a folding function based on a simple hinge structure or cross-rod assembly, and is mostly folded in a single direction (e.g., left-right folding) or two directions (e.g., left-right + up-down folding). Its volume after folding remains relatively large, failing to meet the needs of users for portability and storage space.

### SUMMARY

An objective of the present disclosure is to provide a folding walking aid to alleviate the technical problem in the prior art that the folding walking aid still has a relatively large volume after folding and cannot meet the needs of users for portability and storage space.

The present disclosure provides a folding walking aid, including: a handgrip assembly, a support mechanism, a folding frame, a first locking assembly and a second locking assembly. The support mechanism includes a first leg, a second leg, and a support member. The first leg is rotatably connected to the support member and the second leg, respectively. The handgrip assembly is disposed at a top end of the support mechanism. At least two support mechanisms are provided. The folding frame is provided, at both ends along a horizontal direction, with the support mechanisms. The folding frame is foldable or extendable to make the support mechanisms at the two ends close to or away from each other. The first locking assembly is disposed at a connection between the first leg and the support member and is configured to lock a relative position between the first leg and the support member. The second locking assembly is disposed at a connection between the first leg and the second leg and is configured to lock a relative position between the second leg and the first leg.

Further, the support member is provided on the folding frame; the support member has one end connected to the handgrip assembly and the other end which is a rotating end, and both the first leg and the second leg are rotatably connected to the rotating end, wherein the folding frame is folded or extended to trigger the first locking assembly to unlock/lock rotation of the support member relative to the first leg, and the support member and the first leg rotate relative to each other to trigger the second locking assembly to unlock/lock rotation of the first leg relative to the second leg.

Further, the first locking assembly includes: a first trigger key and a first locking key. The first trigger key is disposed on a side of the rotating end close to the folding frame. The first locking key is retractably disposed on the first leg. When the folding frame is in an extended state, the first trigger key protrudes outwards from the support member, and the first locking key protrudes outwards from the first leg. When the folding frame is folded to a final state, the folding frame presses the first trigger key, so that the first trigger key presses the first locking key, and the first locking key is retracted into the first leg.

Further, the second locking assembly includes: a second trigger key and a second locking key. The second trigger key is disposed on the rotating end of the support member and located on a side facing the second leg. The second locking key is retractably disposed on the second leg. When the support member is in an extended state, an end portion of the second locking key is inserted into the first leg. When the support member is in a folded state, the second trigger key and the second locking key are linked in cooperation, so that the end portion of the second locking key is retracted into the second leg.

Further, the first leg is provided with a mounting hole penetrating through the first leg along the horizontal direction; the second locking assembly further includes a linking member, the linking member being disposed in the mounting hole, and the end portion of the second locking key abuts against the linking member; and the second trigger key presses the linking member to push the second locking key.

Further, a first guide groove is provided on the first leg; the second locking key is disposed at one end of the first guide groove; the second trigger key is disposed in the first guide groove; and when the folding frame is in the extended state, the second trigger key is located at an end of the first guide groove away from the second locking key. When the support member is in the folded state, positions of the second trigger key, the linking member, and the second locking key coincide.

Further, the folding walking aid further includes: a sliding sleeve and a limiting member. The sliding sleeve is disposed on the second leg and slidable along an extension direction of the second leg. The limiting member has one end hinged to the first leg and the other end hinged to the sliding sleeve.

Further, a side of the second leg close to the first leg is provided with a second guide groove; and a side of the first leg close to the second leg is provided with a guide block, the guide block being in sliding fit with the second guide groove.

Further, the folding frame includes two top movable rods and two bottom movable rods; one ends of the two top movable rods are hinged to form a first hinge point, and one ends of the two top movable rods away from the hinge point are free ends and located above the first hinge point; and one ends of the two bottom movable rods are hinged to form a second hinge point, the second hinge point being located below the first hinge point, and one ends of the two bottom movable rods away from the second hinge point are connected to the support mechanisms, wherein the two bottom movable rods and the two top movable rods are in one-to-one correspondence and are arranged crosswise, and the bottom movable rods and the top movable rods that are arranged crosswise are hinged at respective intersections.

Further, the folding walking aid further includes carrying members and rotating arms. The carrying members are disposed on sides of the support mechanisms close to the folding frame, two carrying members are provided, and the two carrying members are respectively disposed on two support mechanisms. Two rotating arms are provided, one ends of the two rotating arms are hinged to the two carrying members in one-to-one correspondence, and the other ends of the rotating arms are hinged to the top movable rods close to the carrying members. When the folding frame is in an extended state, a free end of the top movable rod is lapped on the top of the carrying member, and a hinged connection between the rotating arm and the top movable rod, a hinged connection between the rotating arm and the carrying member and a lap joint between the top movable rod and the carrying member form a triangular structure.

The following beneficial effects are achieved.

In the present disclosure, the folding frame has a self-locking structure. The first locking assembly locks the support member and the first leg, and the second locking assembly locks positions of the first leg and the second leg, which together ensures structural stability of the folding walking aid, achieves erection of the folding walking aid, and enables the folding walking aid to bear gravity for hand support and sitting. When storage is required without use, the self-locking structure of the folding frame is unlocked, the folding frame is folded to reduce a length of the folding walking aid, and the first locking assembly and the second locking assembly are unlocked to enable relative rotation between the support member and the first leg as well as relative rotation between the first leg and the second leg, thereby achieving folding of the folding walking aid in a height direction and a width direction and realizing three-dimensional folding of the folding walking aid in length, height, and width directions, which further compresses a volume of the folding walking aid to meet the needs of users for portability and storage space.

### BRIEF DESCRIPTION OF THE DRAWINGS

In order to more clearly illustrate specific embodiments of the present disclosure or the technical solutions in the prior art, the drawings required for the description of the specific embodiments or the prior art will be briefly introduced below. Obviously, the drawings in the following description are some embodiments of the present disclosure, and for those of ordinary skill in the art, other drawings can be obtained based on these drawings without creative efforts.

FIG. 1 is a schematic structural diagram of a folding walking aid according to an embodiment of the present disclosure;

FIG. 2 is a schematic diagram of a front-view structure of the folding walking aid according to an embodiment of the present disclosure;

FIG. 3 is a schematic structural diagram of the folding walking aid with a folding frame in an extended state according to an embodiment of the present disclosure;

FIG. 4 is a schematic structural diagram of the folding walking aid with the folding frame in a folded state according to an embodiment of the present disclosure;

FIG. 5 is a schematic structural diagram of the folding walking aid in a folded state according to an embodiment of the present disclosure;

FIG. 6 is a schematic structural diagram of a support member in the folding walking aid according to an embodiment of the present disclosure;

FIG. 7 is a schematic structural diagram of a side of a first leg facing the support member in the folding walking aid according to an embodiment of the present disclosure;

FIG. 8 is a schematic structural diagram of a side of the first leg facing a second leg in the folding walking aid according to an embodiment of the present disclosure;

FIG. 9 is a schematic structural diagram of the second leg in the folding walking aid according to an embodiment of the present disclosure;

FIG. 10 is a schematic diagram of a positional relationship between a first trigger key and a first locking key when the first trigger key does not trigger the first locking key in the folding walking aid according to an embodiment of the present disclosure;

FIG. 11 is a schematic diagram of a positional relationship between the first trigger key and the first locking key when the first trigger key triggers the first locking key in the folding walking aid according to an embodiment of the present disclosure;

FIG. 12 is a schematic diagram of a positional relationship between a second trigger key and a second locking key when the second trigger key does not trigger the second locking key in the folding walking aid according to an embodiment of the present disclosure; and

FIG. 13 is a schematic diagram of a positional relationship between the second trigger key and the second locking key when the second trigger key triggers the second locking key in the folding walking aid according to an embodiment of the present disclosure.

### REFERENCE NUMERALS

100: handgrip assembly; 110: seating assembly; 121: flexible backrest; 122: flexible cushion;
200: folding frame; 210: top movable rod; 211: first hinge point; 212: first engaging block; 213: second engaging block; 220: bottom movable rod; 221: second hinge point; 230: carrying member; 240: rotating arm; 250: limiting hook;
300: support member;
400: leg assembly; 410: first leg; 411: first guide groove; 412: guide block; 420: second leg; 421: second guide groove; 430: sliding sleeve; 440: limiting member;
500: first locking assembly; 510: first trigger key; 520: first locking key;
600: second locking assembly; 610: second trigger key; 620: second locking key; and 630: linking member.

### DETAILED DESCRIPTION OF THE EMBODIMENTS

In order to make the objectives, technical solutions, and advantages of the embodiments of the present disclosure clearer, the technical solutions in the embodiments of the present disclosure will be clearly and completely described below in combination with the drawings in the embodiments of the present disclosure. Apparently, the described embodiments are some, but not all, of the embodiments of the present disclosure. The components in the embodiments of the present disclosure generally described and illustrated in the drawings herein can be arranged and designed in a variety of different configurations.

Therefore, the following detailed description of the embodiments of the present disclosure provided in the drawings is not intended to limit the scope of the present disclosure for which protection is sought, but merely represents selected embodiments of the present disclosure. Based on the embodiments in the present disclosure, all other embodiments obtained by those of ordinary skill in the art without creative efforts shall fall within the protection scope of the present disclosure.

It should be noted that similar reference numerals and letters indicate similar items in the following drawings. Therefore, once an item is defined in one drawing, it does not need to be further defined or explained in subsequent drawings.

In the description of the present disclosure, it should be noted that orientations or positional relationships indicated by the terms "center", "upper", "lower", "left", "right", "vertical", "horizontal", "inner", "outer", and the like are based on the orientations or positional relationships shown in the drawings, or customary orientations or positional relationships when the product of the present disclosure is in use, which are merely for the convenience of describing the present disclosure and simplifying the description, and are not intended to indicate or imply that the referred device or element must have a specific orientation, be constructed, or operate in a specific orientation. Therefore, they should not be construed as limitations on the present disclosure. Furthermore, the terms "first", "second", "third", and the like are used merely for distinguishing descriptions and cannot be construed as indicating or implying relative importance.

In addition, terms such as "horizontal" and "vertical" do not imply that a component is required to be absolutely horizontal or vertical, but rather that it can be slightly tilted. For example, "horizontal" merely means that its direction is more horizontal relative to "vertical", and does not mean that the structure must be completely horizontal, but rather that it can be slightly tilted.

In the description of the present disclosure, it should also be noted that, unless otherwise expressly specified and limited, the terms "disposed", "mounted", "connected", and "coupled" should be interpreted in a broad sense. For example, they can refer to fixed connections, detachable connections, or integral connections; they can refer to mechanical connections or electrical connections; they can refer to direct connections or indirect connections through intervening media; or they can refer to internal communication between two components. For those of ordinary skill in the art, the specific meanings of the above terms in the present disclosure can be understood based on specific circumstances.

The present disclosure is described in further detail below through specific embodiments and in combination with the drawings.

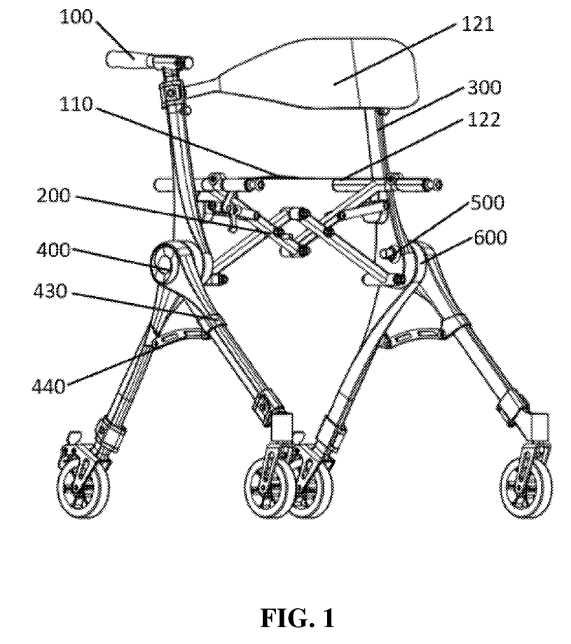

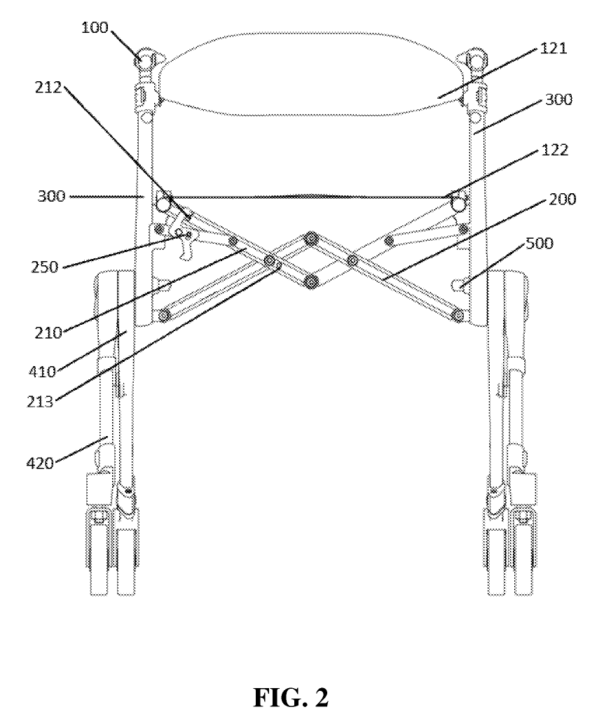

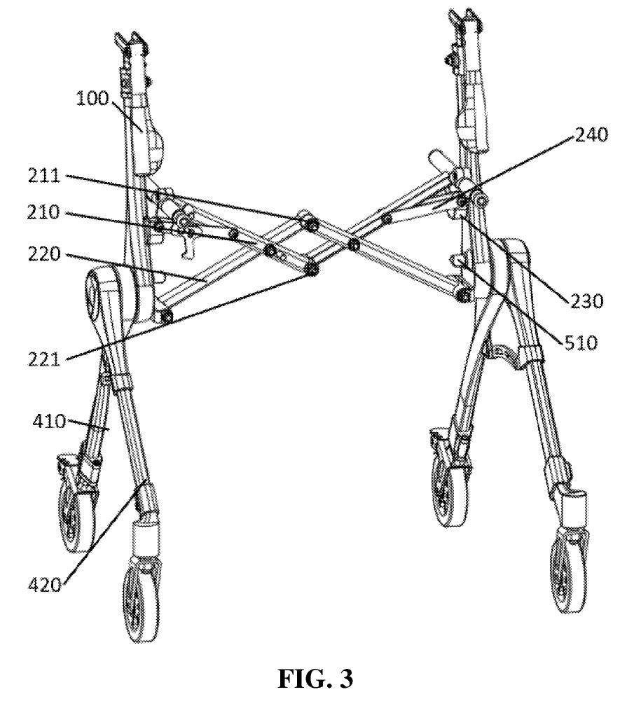

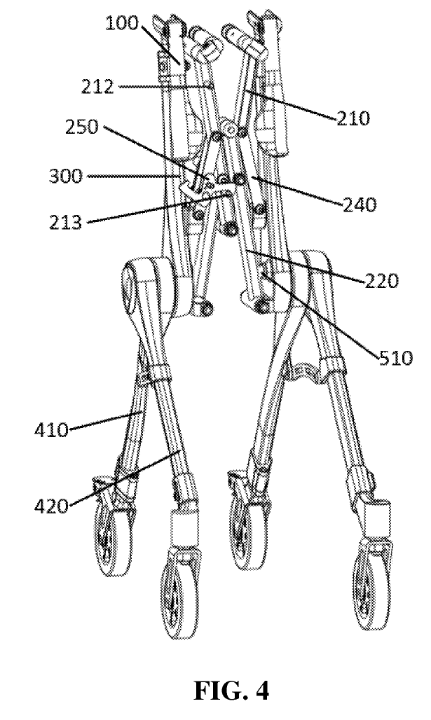

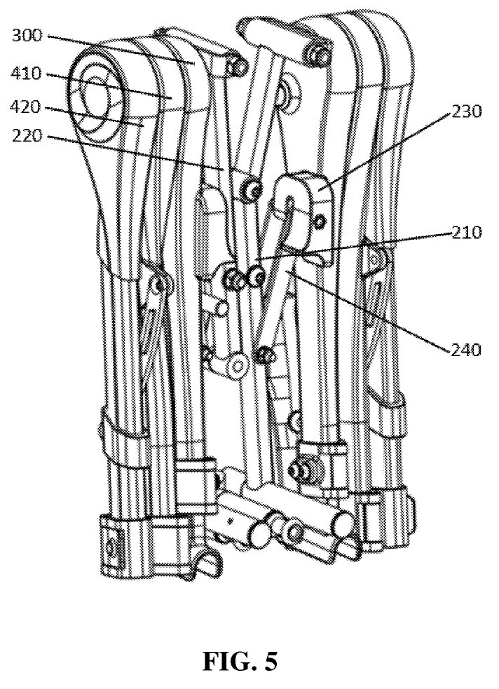

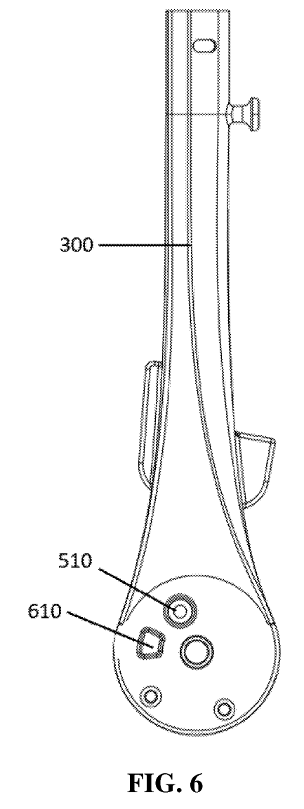

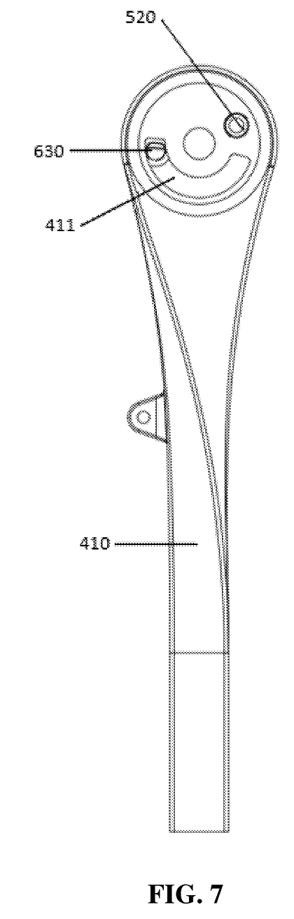

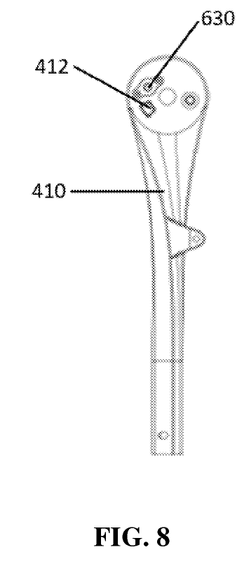

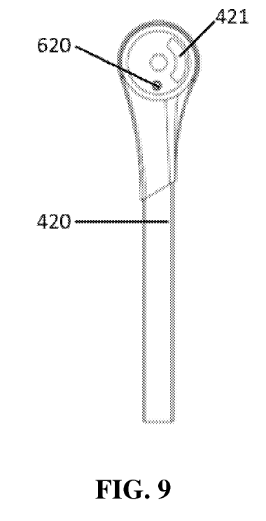

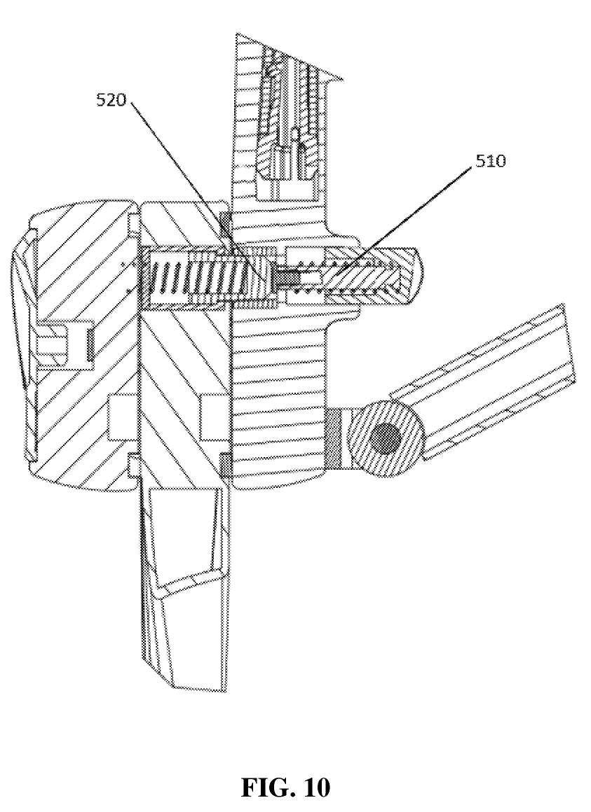

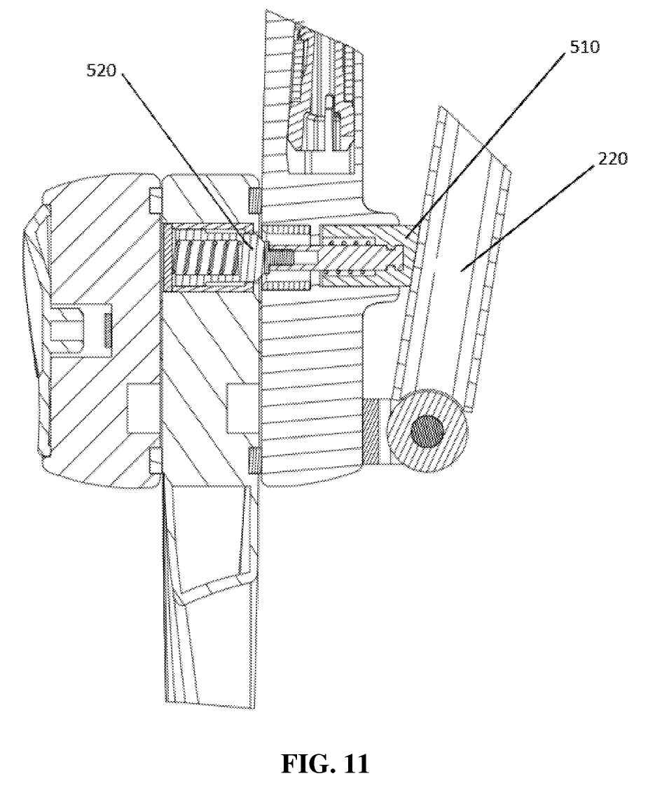

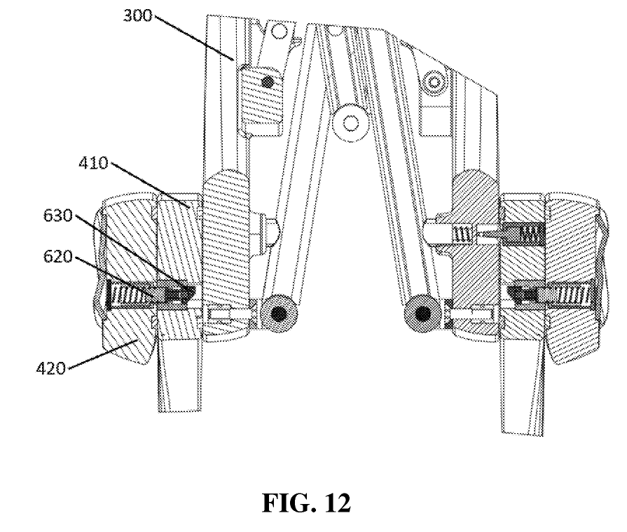

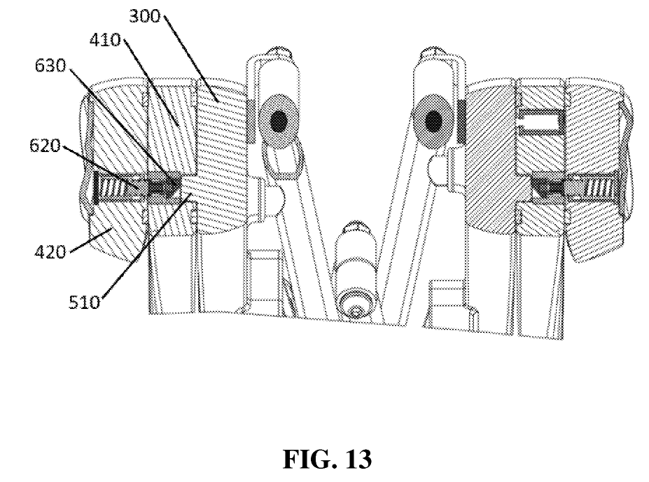

Referring to FIGS. 1-13, a folding walking aid provided in this embodiment includes a handgrip assembly 100, a support mechanism, a folding frame 200, a first locking assembly 500, and a second locking assembly 600.

The support mechanism includes a first leg 410, a second leg 420, and a support member 300. The first leg 410 is rotatably connected to the support member 300 and the second leg 420, respectively. The handgrip assembly 100 is disposed at a top end of the support mechanism. At least two support mechanisms are provided.

The folding frame 200 is provided with the support mechanisms at two ends along a horizontal direction. The folding frame 200 is foldable or extendable to make the support mechanisms at the two ends close to or away from each other. The first locking assembly 500 is disposed at a connection between the first leg 410 and the support member 300 and configured to lock a relative position between the first leg 410 and the support member 300. The second locking assembly 600 is disposed at a connection between the first leg 410 and the second leg 420 and configured to lock a relative position between the second leg 420 and the first leg 410.

Specifically, in the folding walking aid provided in this embodiment, two support mechanisms are provided and respectively disposed at two ends of the folding frame 200. The handgrip assembly 100 is disposed on the two support mechanisms. When the folding walking aid is in use, the first locking assembly 500 and the second locking assembly 600 are in a locked state, and positions of the first leg 410 relative to the support member 300 and of the first leg 410 relative to the second leg 420 are fixed. A user can hold the handgrip assembly 100 for assisted walking.

Before or after use of the folding walking aid, a self-locking structure of the folding frame 200 can be released, and the folding frame 200 is folded so that the two support mechanisms move towards each other, thereby reducing a length of the folding walking aid. The first locking assembly 500 and the second locking assembly 600 are operated to unlock, so that the first leg 410 and the support member 300 as well as the first leg 410 and the second leg 420 are released from the locked state, enabling relative rotation between the first leg 410 and the support member 300 as well as between the first leg 410 and the second leg 420.

In this case, the relative positions among the support member 300, the first leg 410, and the second leg 420 can be adjusted by rotation so that the support member 300, the first leg 410, and the second leg 420 are rotated to overlap with one another, thereby achieving three-dimensional folding in length, height, and width directions, which further compresses a volume of the folding walking aid and reduces occupied space of the folding walking aid.

In this embodiment, the support member 300 is disposed on the folding frame 200. The support member 300 has one end connected to the handgrip assembly 100 and the other end which is a rotating end. Both the first leg 410 and the second leg 420 are rotatably connected to the rotating end. The folding frame 200 is folded or extended to trigger the first locking assembly 500 to unlock or lock rotation of the support member 300 relative to the first leg 410, and the support member 300 and the first leg 410 rotate relative to each other to trigger the second locking assembly 600 to unlock or lock rotation of the first leg 410 relative to the second leg 420.

In the folding walking aid provided in this embodiment, the handgrip assembly 100 is disposed on the two support members 300, and the user can hold the handgrip assembly 100 for assisted walking.

Moreover, in this embodiment, the support member 300, the first leg 410 and the second leg 420 are coaxially disposed.

Specifically, during the folding of the folding frame 200, the folding frame 200 triggers the first locking assembly 500, and the first locking assembly 500 is unlocked to enable relative rotation between the support member 300 and the first leg 410. In this case, the support member 300 is rotated so that the support member 300 coincides with the first leg 410, thereby reducing a height of the folding walking aid.

During the rotation, the support member 300 triggers the second locking assembly 600, and the second locking assembly 600 is unlocked to enable relative rotation between the first leg 410 and the second leg 420. In this case, the second leg 420 is rotated so that the second leg 420 is rotated to an angle where it coincides with the first leg 410 and the support member 300, thereby achieving three-dimensional folding in length, height, and width directions, which further compresses the volume of the folding walking aid and reduces occupied space of the folding walking aid.

In this embodiment, the first locking assembly 500 includes a first trigger key 510 and a first locking key 520.

The first trigger key 510 is disposed on a side of the rotating end close to the folding frame 200. The first locking key 520 is retractably disposed on the first leg 410.

When the folding frame 200 is in an extended state, the first trigger key 510 protrudes outwards from the support member 300, and the first locking key 520 protrudes outwards from the first leg 410. When the folding frame 200 is folded to a final state, the folding frame 200 presses the first trigger key 510 so that the first trigger key 510 presses the first locking key 520, and the first locking key 520 retracts into the first leg 410.

In this embodiment, the first trigger key 510 and the first locking key 520 form a linked locking structure, achieving simultaneous triggering of the folding action and the unlocking operation.

Specifically, in this embodiment, the first trigger key 510 is embedded into the support member 300, the first locking key 520 is embedded into the first leg 410, and a resilient return member is arranged at the bottom of the first locking key 520. When the folding frame 200 is in the extended state, the first locking key 520 protrudes outwards from a surface of the first leg 410, and the first locking key 520 is positioned opposite the first trigger key 510. With this structure, the first trigger key 510 is pressed so as to press the first locking key 520 into the first leg 410.

When the folding frame 200 transitions from the extended state to the folded state, the folding frame 200 presses the first trigger key 510 to drive the first locking key 520 to retract, thereby releasing the rotational connection between the support member 300 and the first leg 410. When the folding frame 200 is in the extended state, bidirectional outward protrusion of the first locking key 520 forms a physical lock, preventing accidental folding due to accidental touch during use of the folding walking aid for assisted walking, thereby ensuring stability during use.

Moreover, during the folding of the folding frame 200, merely operating the folding frame 200 can automatically accomplish the unlocking of the first locking key 520, which does not require an additional manual unlocking action, thereby improving continuity and convenience of the folding operation. At the same time, an integrated triggering-and-locking structure implements functions through mechanical linkage, which does not require adding a complex driving device, thereby maintaining lightweight characteristic of the walking aid structure.

In this embodiment, the second locking assembly 600 includes a second trigger key 610 and a second locking key 620.

The second trigger key 610 is disposed on the rotating end of the support member 300 and located on a side facing the second leg 420. The second locking key 620 is retractably disposed on the second leg 420. When the support member 300 is in an extended state, an end portion of the second locking key 620 is inserted into the first leg 410. When the support member 300 is in a folded state, the second trigger key 610 and the second locking key 620 are linked in cooperation, so that the end portion of the second locking key 620 is retracted into the second leg 420.

Similarly, in this embodiment, the cooperative design of the second trigger key 610 and the second locking key 620 achieves automated unlocking and locking of the folding action of the leg assembly 400. When the support member 300 rotates and folds, the second trigger key 610 displaces with the support member 300 and forms mechanical interference with the second locking key 620, causing the second locking key 620 to withdraw from an insertion position on the first leg 410, thereby unlocking the second leg 420.

Specifically, in an unfolded state, the second locking key 620 is inserted into the first leg 410 to form a rigid connection, fixing a relative position between the first leg 410 and the second leg 420, thereby preventing accidental folding of the first leg 410 and the second leg 420 during use of the folding walking aid.

During the folding of the support member 300, the rotation action of the support member 300 drives the second trigger key 610 to move together and triggers the second locking key 620 to be unlocked, without a need to separately operate the second locking assembly 600, so that the folding action of the first leg 410 and the second leg 420 is linked with the folding of the support member 300.

In this embodiment, the first leg 410 is provided with a mounting hole that penetrates the first leg 410 in the horizontal direction. The second locking assembly 600 further includes a linking member 630. The linking member 630 is disposed in the mounting hole, and the end portion of the second locking key 620 abuts against the linking member 630. The second trigger key 610 presses the linking member 630 to push the second locking key 620.

With the cooperative structure of the linking member 630 and the mounting hole, a transmission path for axial transmission of the second locking key 620 is achieved. Specifically, a top surface of the linking member 630 in this embodiment is an inclined plane or a curved surface. When the second trigger key 610 rotates with the support member 300 to the position of the linking member 630, the second trigger key 610 presses the linking member 630 along a top surface of the linking member 630, causing the linking member 630 to move in a horizontal direction within the mounting hole towards the second locking key 620, thereby pressing the second locking key 620.

The linking member 630 is a rigid transmission component, which can prevent misaligned contact between the second trigger key 610 and the second locking key 620, ensure stable transmission of the unlocking action, and eliminate jamming during unlocking. Moreover, the mounting hole provides a guiding function for the linking member 630 so that the linking member 630 can accurately press the second locking key 620.

In this embodiment, the first leg 410 is provided with a first guide groove 411. The second locking key 620 is disposed at one end of the first guide groove 411. The second trigger key 610 is disposed in the first guide groove 411. When the folding frame 200 is in the extended state, the second trigger key 610 is located at an end of the first guide groove 411 away from the second locking key 620. When the support member 300 is in the folded state, positions of the second trigger key 610, the linking member 630, and the second locking key 620 coincide.

The second locking key 620 is adapted to the first guide groove 411, so that the first guide groove 411 can guide a movement path of the second locking key 620, and determine a movement path of the second locking member as well as rotation paths of the first leg 410 and the second leg 420, thereby making a cooperative relationship among the second trigger key 610, the linking member 630, and the second locking key 620 more accurate. During the folding of the first leg 410 and the second leg 420, the second trigger key 610 slides along a path defined by the first guide groove 411, and finally coincides with positions of the linking member 630 and the second locking key 620 and presses the linking member 630, so that the linking member 630 can press the second locking key 620.

Moreover, the first guide groove 411 can assist in achieving rotational limiting on the first leg 410 and the second leg 420, preventing an excessively rotation angle of the first leg 410 and the second leg 420 during extension, thereby enhancing torsional stiffness of the leg assembly 400 in the unfolded state.

Specifically, in this embodiment, the first guide groove 411 is a through groove that penetrates the first leg 410 along a thickness direction of the first leg 410.

In this embodiment, the folding walking aid further includes a sliding sleeve 430 and a limiting member 440. The sliding sleeve 430 is disposed on the second leg 420 and slidable along an extension direction of the second leg 420. The limiting member 440 has one end hinged to the first leg 410 and the other end hinged to the sliding sleeve 430.

Specifically, during the folding of the first leg 410 and the second leg 420, the sliding sleeve 430 slides axially along the second leg 420, one end of the limiting member 440 is hinged to the first leg 410, and the other end of the limiting member 440 is hinged to the sliding sleeve 430. With this structure, the rotation path of the second leg 420 is always limited within a fixed plane. When the first leg 410 and the second leg 420 are folded or extended, the sliding sleeve 430 and the limiting member 440 form a limiting structure to prevent excessive rotation of the first leg 410 and the second leg 420.

Moreover, in the extended state, the first leg 410, the second leg 420, the limiting member 440, and the sliding sleeve 430 form a triangular stable configuration. The position is locked by friction between the sliding sleeve 430 and the second leg 420, enhancing structural strength of the second leg 420 and the first leg 410 and preventing lateral deformation of the first leg 410 and the second leg 420 during walking.

In this embodiment, a side of the second leg 420 close to the first leg 410 is provided with a second guide groove 421. A side of the first leg 410 close to the second leg 420 is provided with a guide block 412. The guide block 412 is in sliding fit with the second guide groove 421.

Specifically, during the relative rotation of the first leg 410 and the second leg 420 to achieve folding, the guide block 412 slides within the second guide groove 421 along an extension direction of the second guide groove 421, so that the second leg 420 and the first leg 410 only rotate relative to each other, preventing deviation of the first leg 410 and the second leg 420 in other directions during folding, and ensuring that the second leg 420 can always fit closely against the first leg 410.

When the folding walking aid is in use, the first leg 410 and the second leg 420 are in the extended state, and the guide block 412 slides to one end of the second guide groove 421 and abuts against a groove wall of the second guide groove 421. In this case, the second guide groove 421 can provide a limiting function for the guide block 412, preventing further movement of the guide block 412, thereby avoiding an excessively large opening angle between the first leg 410 and the second leg 420.

It should be noted herein that, in this embodiment, the guide block 412 and the second trigger key 610 are both bosses, and the guide block 412 and the first leg 410 as well as the second trigger key 610 and the support member 300 are respectively an integrated structure.

In this embodiment, the folding frame 200 includes two top movable rods 210 and two bottom movable rods 220.

One ends of the two top movable rods 210 are hinged to form a first hinge point 211, and one ends of the two top movable rods 210 away from the hinge point are free ends and located above the first hinge point 211. One ends of the two bottom movable rods 220 are hinged to form a second hinge point 221, the second hinge point 221 are located below the first hinge point 211, and one ends of the two bottom movable rods 220 away from the second hinge point 221 are connected to the support mechanisms.

Moreover, the two bottom movable rods 220 and the two top movable rods 210 are in one-to-one correspondence and are arranged crosswise, and the bottom movable rods 220 and the top movable rods 210 that are arranged crosswise are hinged at respective intersections.

Specifically, in this embodiment, the two top movable rods 210 and the two bottom movable rods 220 are arranged in a rhombus configuration to form a cross-folded connecting rod, and are hinged at all intersections. A hinge point of the two top movable rods 210 is located below a hinge point of the two bottom movable rods 220, and one ends of the two top movable rods 210 away from the hinge point are located above ends of the two bottom movable rods 220 away from the hinge point.

With this structure, the ends of the two top movable rods 210 away from the hinge point are free ends, and the ends of the two bottom movable rods 220 away from the hinge point are respectively connected to the two support members 300 to form fixed ends. When the cross-folded connecting rod is being folded or extended, the fixed ends of the two bottom movable rods 220, restricted by the support members 300, move only in the horizontal direction without any vertical displacement, while the free ends of the two top movable rods 210 move horizontally along with the folding action and simultaneously move vertically under the action of the hinge structure.

As an implementable way, the folding frame 200 in this embodiment is a four-bar linkage structure, and can alternatively be replaced with another foldable frame structures such as two-bar, three-bar, six-bar, or eight-bar ones, which can achieve the same folding effect at two ends in the horizontal direction. Details are described herein again.

In this embodiment, the folding walking aid further includes carrying members 230 and rotating arms 240.

The carrying members 230 in this embodiment are disposed on sides of the support members 300 close to the folding frame 200, two carrying members 230 are provided, and the two carrying members 230 are respectively disposed on the two support members 300.

Moreover, two rotating arms 240 are provided, one end of each of the two rotating arms 240 is hinged to a respective one of the two carrying members 230, and the other end of each of the rotating arms 240 is hinged to the top movable rod 210 close to the carrying member 230. When the folding frame 200 is in the extended state, a free end of the top movable rod 210 is lapped on the top of the carrying member 230, and a hinged connection between the rotating arm 240 and the top movable rod 210, a hinged connection between the rotating arm 240 and the carrying member 230, and a lap joint between the top movable rod 210 and the carrying member 230 form a triangular structure.

Specifically, taking the rotating arm 240, the top movable rod 210, the carrying member 230, and the support member 300 on one side as an example, in this embodiment, one end of the rotating arm 240 is hinged to the top movable rod 210, the other end of the rotating arm 240 is hinged to the carrying member 230, and the carrying member 230 is fixedly disposed on the support member 300. With this structure, when the folding frame 200 is folded or extended, the top movable rod 210 rotates under the push of an external force. Since the top movable rod 210 and the rotating arm 240 are hinged, the top movable rod 210 can rotate relative to the rotating arm 240. During the rotation of the top movable rod 210, the rotating arm 240 can simultaneously rotate about a hinged connection with the carrying member 230 as a center of rotation, thereby ensuring flexible rotation of the top movable rod 210 and preventing an excessively large rotation angle of the top movable rod 210.

In addition, when the folding frame 200 is in the extended state, the bottom of the free end of the top movable rod 210 abuts against a top surface of the carrying member 230, and the carrying member 230 can support the free end of the top movable rod 210, so as to ensure stability of the top movable rod 210 when extended and to distribute a force on the folding frame 200. In this case, the rotating arm 240, the support rod, and the top movable rod 210 form a stable triangular structure. Corner points of the triangular structure are respectively the hinged connection between the rotating arm 240 and the top movable rod 210, the hinged connection between the rotating arm 240 and the carrying member 230, and the lap joint between the top movable rod 210 and the carrying member 230, thereby further improving the structural stability of the telescopic frame and the support rod.

It should be noted herein that, in this embodiment, the folding frame 200 is provided with a limiting hook, and the folding frame 200 achieves a self-locking function through the limiting hook 250.

Specifically, in this embodiment, the limiting hook 250 is provided with two hook bodies at its upper and lower ends, respectively. A middle part of the limiting hook 250 is provided on the rotating arm 240 on one side of the folding frame 200 through a rotating shaft. A limiting member is provided on one side of the pivot shaft. The limiting hook 250 is provided with an arc-shaped limiting slot, and the limiting member is inserted into the limiting slot, so that the limiting hook 250 can rotate slightly along the rotating shaft. A resilient return member further sleeves on the limiting member. In this embodiment, the resilient return member is specifically a torsion spring. The torsion spring has one end fixed to the limiting member and the other end connected to the rotating shaft, thereby achieving automatic return of the limiting hook 250.

Moreover, in this embodiment, the top movable rod 210 of the folding frame 200 closest to the limiting hook 250 is provided with a first engaging block 212 and a second engaging block 213. When the folding frame 200 is in a fully extended state, a top hook body of the limiting hook 250 is in snap-fit engagement with the first engaging block 212, so that the folding frame 200 can remain in the fully extended state. When the folding frame 200 needs to be folded, the limiting hook 250 can be rotated slightly to disengage the top hook body of the limiting hook 250 from the first engaging block 212, thereby releasing the constraint on the folding frame 200 and facilitating the folding operation on the folding frame 200.

Correspondingly, when the folding frame 200 is folded to a final state, a bottom hook body of the limiting hook 250 is in snap-fit engagement with the second engaging block 213, forming a constraint on the folding frame 200, so that the folding frame 200 can remain in the fully folded state. Similarly, when the folding frame 200 needs to be extended, the limiting hook 250 can be rotated slightly to disengage the bottom hook body of the limiting hook 250 from the second engaging block, thereby releasing the constraint on the folding frame 200 and facilitating the extending operation on the folding frame 200.

In this embodiment, the free end of the top movable rod 210 has a cylindrical structure. The top surface of the carrying member 230 is a concave structure adapted to the cylindrical structure. When the folding walking aid is in the extended state, the support member 300 is arranged obliquely, and a top end of the support member 300 is inclined towards a side away from a seating assembly 110.

Specifically, in this embodiment, an extension direction of an axis of the cylindrical structure is perpendicular to a telescopic direction of the folding frame 200. A free end of the cylindrical structure is adapted to the concave surface of the carrying member 230, so that the free end can accurately fall into the concave structure, and a curved surface of the cylindrical structure conforms to the concave surface, thereby enabling the top surface of the carrying member 230 to bear the force more uniformly and preventing excessive local stress on a force-bearing plane of the carrying member 230.

The support member 300 is arranged obliquely such that, when the folding frame 200 is unfolded, a forward tilting moment is generated, which counterbalances the gravity applied by the user on the seating assembly 110, thereby improving overall stability of the folding walking aid. Moreover, with this structure, a length of a handle in the handgrip assembly 100 can be reduced to some extent, eliminating the need for an excessively long handle.

It should be noted herein that the handgrip assembly 100 in this embodiment specifically includes two rotatable folding handles. The two folding handles are respectively disposed at top ends of the two support members 300 in one-to-one correspondence. An extension direction of each folding handle is perpendicular to the telescopic direction of the folding frame 200 and faces an inclined direction of the support member 300. With this structure, the folding handle is folded by rotation. When the folding handle is in a folded state, the folding handle fits against the support member 300 and can move along with the support member 300.

In addition, the support member 300 in this embodiment is further provided with the seating assembly 110.

The seating assembly 110 includes a flexible backrest 121 and a flexible cushion 122. When the folding walking aid is in the extended state, two ends of the flexible backrest 121 are respectively fixed to the two support members 300 and are in a taut state. Two ends of the flexible cushion 122 are respectively connected to the free ends of the two cylindrical structures and are in a taut state. Moreover, in this embodiment, the flexible cushion 122 is disposed on a side of the support member 300 away from the folding handle. With this structure, the user can sit on the flexible cushion 122 and lean against the flexible backrest 121, and the support member 300 arranged obliquely can ensure balance of the folding walking aid.

Moreover, during folding, since the flexible backrest 121 and the flexible cushion 122 are made of soft materials, they can be folded directly without affecting overall folding of the folding walking aid.

It should be noted herein that the folding walking aid provided in this embodiment further includes a plurality of rollers. The plurality of rollers are respectively detachably disposed at bottom ends of the first leg 410 and the second leg 420, so as to facilitate pushing when the folding walking aid is in use and to allow easy disassembly during storage.

Finally, it should be noted that the above embodiments are merely intended to describe the technical solutions of the present disclosure instead of limiting the present disclosure. Although the present disclosure is described in detail with reference to the above embodiments, those of ordinary skill in the art should understand that they can still make modifications to the technical solutions described in the above embodiments, or make equivalent replacements to some or all of the technical features therein. These modifications or replacements do not make the essence of corresponding technical solutions depart from the scope of the technical solutions of the embodiments of the present disclosure.

1. A folding walking aid, comprising: a handgrip assembly; wherein the folding walking aid further comprises:
a support mechanism, comprising a first leg, a second leg, and a support member, the first leg being rotatably connected to the support member and the second leg, respectively, the handgrip assembly being disposed at a top end of the support mechanism, and at least two support mechanisms being provided;
a folding frame provided at two ends along a horizontal direction with the support mechanisms, the folding frame being foldable or extendable to make the support mechanisms at the two ends close to or away from each other;
a first locking assembly disposed at a connection between the first leg and the support member and configured to lock a relative position between the first leg and the support member; and
a second locking assembly disposed at a connection between the first leg and the second leg and configured to lock a relative position between the second leg and the first leg.

2. The folding walking aid according to claim 1, wherein the support member is disposed on the folding frame;
the support member has one end connected to the handgrip assembly and the other end which is a rotating end, and both the first leg and the second leg are rotatably connected to the rotating end;
wherein the folding frame is folded or extended to trigger the first locking assembly to unlock/lock rotation of the support member relative to the first leg, and the support member and the first leg rotate relative to each other to trigger the second locking assembly to unlock/lock rotation of the first leg relative to the second leg.

3. The folding walking aid according to claim 2, wherein the first locking assembly comprises:
a first trigger key disposed on a side of the rotating end close to the folding frame; and
a first locking key retractably disposed on the first leg;
wherein when the folding frame is in an extended state, the first trigger key protrudes outwards from the support member, and the first locking key protrudes outwards from the first leg; and
when the folding frame is folded to a final state, the folding frame presses the first trigger key, so that the first trigger key presses the first locking key, and the first locking key is retracted into the first leg.

4. The folding walking aid according to claim 2, wherein the second locking assembly comprises:
a second trigger key disposed on the rotating end of the support member and located on a side facing the second leg; and
a second locking key retractably disposed on the second leg;
wherein when the support member is in an extended state, an end portion of the second locking key is inserted into the first leg; and
when the support member is in a folded state, the second trigger key and the second locking key are linked in cooperation, so that the end portion of the second locking key is retracted into the second leg.

5. The folding walking aid according to claim 4, wherein the first leg is provided with a mounting hole penetrating through the first leg along the horizontal direction;
the second locking assembly further comprises a linking member, the linking member being disposed in the mounting hole, and the end portion of the second locking key abuts against the linking member; and
the second trigger key presses the linking member to push the second locking key.

6. The folding walking aid according to claim 5, wherein a first guide groove is provided on the first leg;
the second locking key is disposed at one end of the first guide groove;
the second trigger key is disposed in the first guide groove;
when the folding frame is in the extended state, the second trigger key is located at an end of the first guide groove away from the second locking key; and
when the support member is in the folded state, positions of the second trigger key, the linking member, and the second locking key coincide.

7. The folding walking aid according to claim 4, wherein the folding walking aid further comprises:
a sliding sleeve disposed on the second leg and slidable along an extension direction of the second leg; and
a limiting member having one end hinged to the first leg and the other end hinged to the sliding sleeve.

8. The folding walking aid according to claim 4, wherein a side of the second leg close to the first leg is provided with a second guide groove; and
a side of the first leg close to the second leg is provided with a guide block, the guide block being in sliding fit with the second guide groove.

9. The folding walking aid according to claim 1, wherein the folding frame comprises two top movable rods and two bottom movable rods;
one ends of the two top movable rods are hinged to form a first hinge point, and one ends of the two top movable rods away from the hinge point are free ends and located above the first hinge point; and
one ends of the two bottom movable rods are hinged to form a second hinge point, the second hinge point being located below the first hinge point, and one ends of the two bottom movable rods away from the second hinge point are connected to the support mechanisms;
wherein the two bottom movable rods and the two top movable rods are in one-to-one correspondence and are arranged crosswise, and the bottom movable rods and the top movable rods that are arranged crosswise are hinged at respective intersections.

10. The folding walking aid according to claim 9, wherein the folding walking aid further comprises carrying members and rotating arms;
wherein the carrying members are disposed on sides of the support mechanisms close to the folding frame, two carrying members are provided, and the two carrying members are respectively disposed on the two support mechanisms; and
two rotating arms are provided, one ends of the two rotating arms are hinged to the two carrying members in one-to-one correspondence, and the other ends of the rotating arms are hinged to the top movable rods close to the carrying members;
wherein when the folding frame is in an extended state, a free end of the top movable rod is lapped on the top of the carrying member, and a hinged connection between the rotating arm and the top movable rod, a hinged connection between the rotating arm and the carrying member, and a lap joint between the top movable rod and the carrying member form a triangular structure.

11. The folding walking aid according to claim 3, wherein the second locking assembly comprises:
a second trigger key disposed on the rotating end of the support member and located on a side facing the second leg; and
a second locking key retractably disposed on the second leg;
wherein when the support member is in an extended state, an end portion of the second locking key is inserted into the first leg; and
when the support member is in a folded state, the second trigger key and the second locking key are linked in cooperation, so that the end portion of the second locking key is retracted into the second leg.

12. The folding walking aid according to claim 11, wherein the first leg is provided with a mounting hole penetrating through the first leg along the horizontal direction;
the second locking assembly further comprises a linking member, the linking member being disposed in the mounting hole, and the end portion of the second locking key abuts against the linking member; and
the second trigger key presses the linking member to push the second locking key.

13. The folding walking aid according to claim 12, wherein a first guide groove is provided on the first leg;
the second locking key is disposed at one end of the first guide groove;
the second trigger key is disposed in the first guide groove;
when the folding frame is in the extended state, the second trigger key is located at an end of the first guide groove away from the second locking key; and
when the support member is in the folded state, positions of the second trigger key, the linking member, and the second locking key coincide.

14. The folding walking aid according to claim 11, wherein the folding walking aid further comprises:
a sliding sleeve disposed on the second leg and slidable along an extension direction of the second leg; and
a limiting member having one end hinged to the first leg and the other end hinged to the sliding sleeve.

15. The folding walking aid according to claim 11, wherein a side of the second leg close to the first leg is provided with a second guide groove; and
a side of the first leg close to the second leg is provided with a guide block, the guide block being in sliding fit with the second guide groove.
